(19) United States
(12) Patent Application Publication
(10) Pub. No.: US 2010/0269144 A1
(43) Pub. Date: Oct. 21, 2010

(54) SYSTEMS AND METHODS FOR INCORPORATING USER GENERATED CONTENT WITHIN A VOD ENVIRONMENT

(75) Inventors: Robert Forsman, Sugar Hill, GA (US); Hugh Watkins, Canton, GA (US); Charles H. Dasher, Lawrenceville, GA (US); Jennifer A. Schultz, Lawrenceville, GA (US); Paul J. Canter, JR., Gainesville, GA (US); Christopher C. Phillips, Hartwell, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tandberg Television, Inc.

(21) Appl. No.: 12/494,425

(22) Filed: Jun. 30, 2009

Related U.S. Application Data
(60) Provisional application No. 61/170,406, filed on Apr. 17, 2009.

(51) Int. Cl. H04N 7/173

(52) U.S. Cl. 725/92; 725/93

(57) ABSTRACT

In one embodiment, a computer system hosts a web site allowing users via the Internet to post video clips, view video clips, or provide feedback regarding a viewed video clip, wherein the computer system selects the most popular video clips based on certain criteria to make available to a video service provider. In one embodiment, the computer system transcodes the video clip received at the web site into a format compatible with a VOD system associated with a cable service provider, and generates the appropriate metadata based on input from the user posting the video clip based in part on values determined by the computer system and based in part on default values determined by an administrator. Subscribers to a cable service provider can then select and view the video clips in the VOD system by invoking a VOD service offered by the cable service provider.

### CROSS REFERENCE TO RELATED APPLICATIONS

This application claims priority to U.S. Provisional Appl. 61/170,406, filed on Apr. 17, 2009, the contents of which are incorporated by reference.

### FIELD OF INVENTION

The present invention generally pertains to identification of video programming to be incorporated into a video-on-demand (VOD) system for subsequent viewing by subscribers of a cable system.

### BACKGROUND OF THE INVENTION

Video-on-Demand (“VOD”) service is often provided on cable systems to subscribers. Fundamentally, the VOD service relies on a capability of maintaining a store of video programs that are available for selection and viewing by users of the cable system upon request, in real-time. This capability can be used to provide various forms of VOD services, which include residential selection of movies to cable subscribers. These movies may be part of the subscriber's subscription plan, or the viewing of the movie can be charged individually by the service provider (such as often is the case for premium events). Similar variations of the service can also be found in hotel video services, where pay-per-movie services are made available for a fee to hotel guests.

Obviously, the selection of programs available for viewing to a cable subscriber is limited to those video programs that are stored in such VOD systems. There is a tradeoff between storing all possible video programs and the cost of storage equipment. The cost of maintaining storage for video programming provides a limit on the number of videos that are stored and made available. While this limit may vary with each service provider, there is a limit nevertheless.

The videos stored in a VOD system typically are comprised of professionally produced programs. Amateur or user generated content has generally not been included, because the cost of providing the video was expensive relative to the demand from cable subscribers to view such video programs. However, the recent popularity of video networking web sites, such as YouTube®, have shown an increased demand for viewing user generated content (“UGC”).

It would be desirable to make such UGC available to viewers of a cable system, but because storage is limited, it is not practical to simply store each and every possible UGC video that could be provided by users. Further, certain steps have to be carried out in order to add a video program to the VOD library (called “placing” a video in a VOD server) in a cable system. While this could be done manually, doing so would require undue administration and human operator time, and thus would not be cost effective. In some cases, it would be desirable to automate aspects of the process of placing UGC content in a VOD server, thereby reducing costs associated with administrating such VOD content. Therefore, systems and methods are required to facilitate the placing of certain videos into the VOD system.

### BRIEF SUMMARY OF THE INVENTION

The present invention is generally directed to a system (“System”) allowing users to determine, in part, video content that is placed into a VOD system of a cable system. The users interact with a web site using a personal computer to potentially upload videos, view videos, or at least provide feedback regarding existing videos uploaded by others. The System determines which videos are deemed “popular” based on various criteria, such as how many times a video has been viewed, how viewers rate the video, or other criteria.

The System then selects which videos to place into the VOD system based on configured criteria. The System transcodes the uploaded videos as necessary and formulates the necessary data, including metadata, required to upload the user generated content into the VOD system. Once uploaded into the VOD system, cable system viewers, including potentially the user that originally uploaded the video, can then view the video by accessing the cable system's VOD service. The System periodically culls UGC by replacing, deleting, or otherwise removing UGC files.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1a illustrates one embodiment of the invention of a System interfacing with a web set and a VOD system,

FIG. 1b illustrates another embodiment of the present invention,

FIG. 2 illustrates one embodiment of the Asset Placement System,

FIG. 3 illustrates a flow diagram of user functions on the web site according to one embodiment,

FIG. 4 illustrates one embodiment of the steps performed by the Asset Placement System,

FIG. 5 illustrates a package structure according to an embodiment of the invention,

FIG. 6 illustrates one embodiment of the database structure associated with the Asset Placement System,

FIG. 7 illustrates one embodiment of a user interface,

FIG. 8 illustrates another embodiment of a user interface, and

FIG. 9 illustrates a flow diagram of user functions on the VOD system according to one embodiment.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

As should be appreciated, the embodiments may be implemented in various ways, including as methods, apparatus, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer-readable program products. It should be understood that each block of the block diagrams and flowchart illustrations, respectively, may be implemented in part by computer-readable program instructions, e.g., as logical steps or operations executing on a processor in a computing system. These computer-readable program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

Accordingly, blocks of the block diagrams and flowchart illustrations support various combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

As generally used herein, an “uploaded” video pertains to a video program (“video clip”) comprising user generated content that has been received and stored by a web server. A “placed” video pertains to the uploaded video which is subsequently made available on a VOD server. An uploaded video program may be stored but not yet made available (that is, placed) in the VOD server. Further, once a video program is converted, so to speak, into a placed video, the video program may or may not be retained in its original form. The context of whether a video refers to the uploaded video or the placed video will be clear from the context.

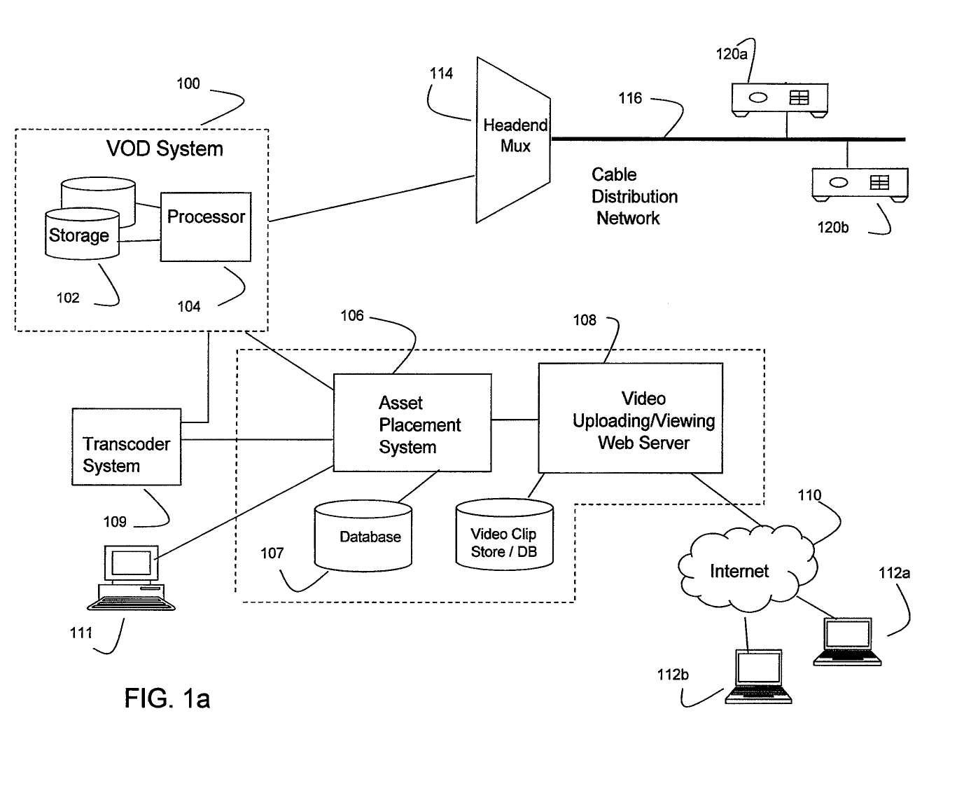

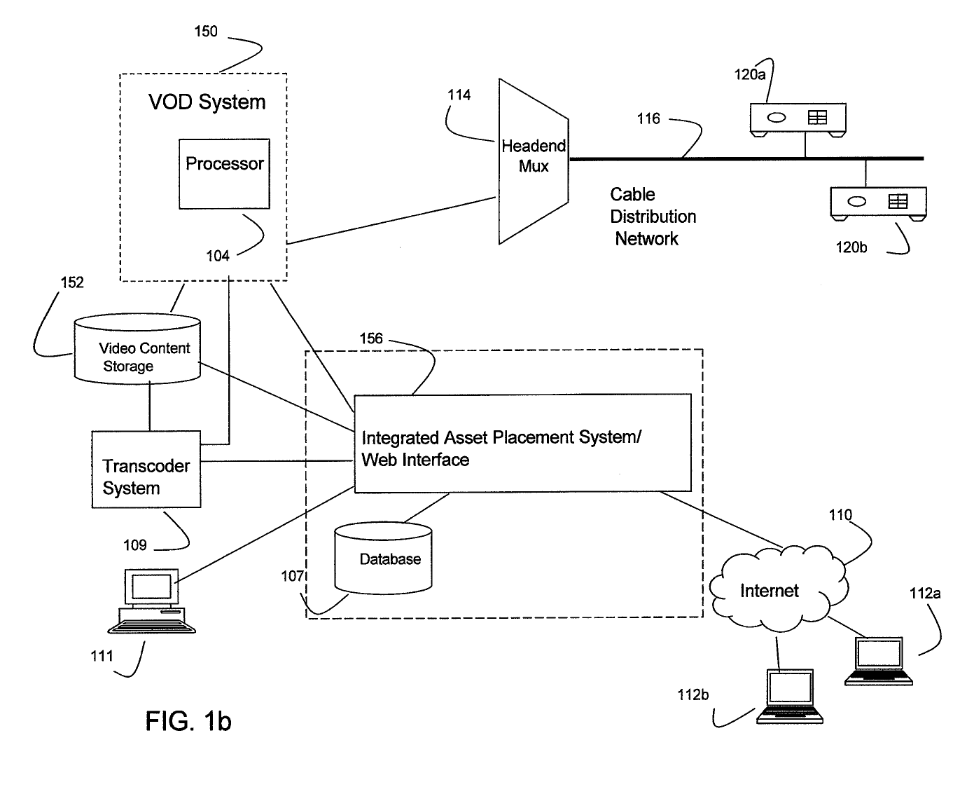

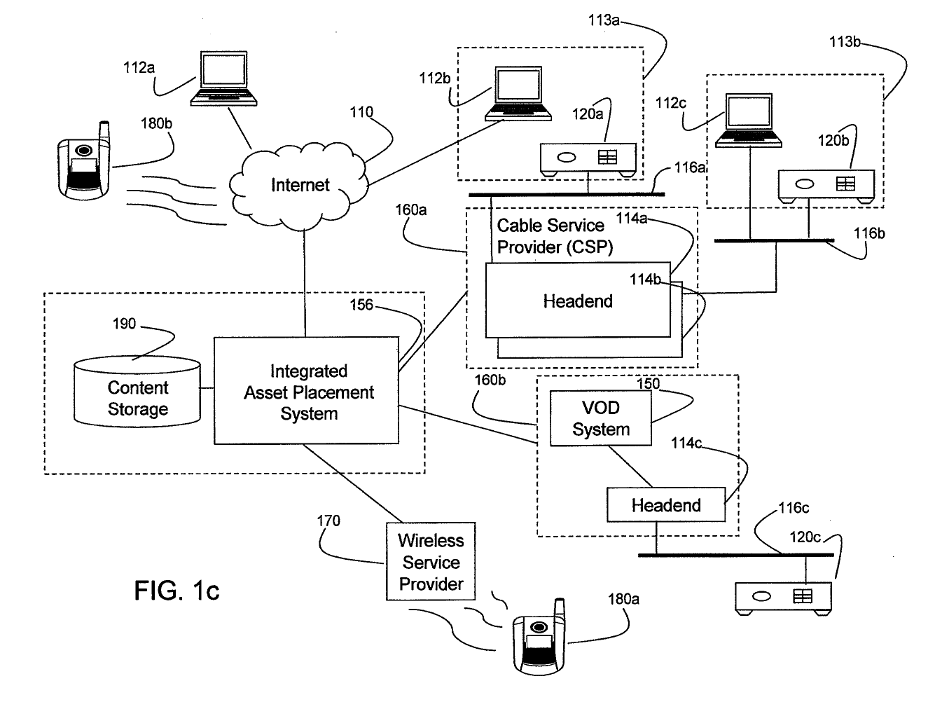

Turning now to FIG. 1a, one embodiment 101 of the present invention is disclosed. At a high level, in this embodiment, an Asset Placement System (“APS”) 106 is positioned so as to communicate with both a Video Uploading Web Server (“Web Site”) 108 and a VOD system 100. At a high level, the APS 106 receives measurement related data from the Web Site 108 and ascertains which videos are considered the most “popular” videos based on various Web Site viewers as represented by computers 112a, 112b. The APS 106 then retrieves the most popular videos as needed, generates the appropriate metadata (which is information about the videos), and then uploads the videos to the VOD system 100. In this particular embodiment, the APS 106 comprises a different data processing system from the Web Site 108. Thus, it is possible that the Web Site 108 could be a third party social networking site that allows users to upload UGC.

Thus, the process of uploading a video clip begins with the user accessing the Web Site 108. These users typically generate video using consumer electronic devices, such as cell phones with video capability, video recorders, personal computers, or any other video generating electronics. These users typically use a computer 112a, 112b accessing the Internet 110, to upload (or “post”) the video to the Web Site 108. Not all users necessarily upload video; many users may only view previously posted videos and/or may provide feedback on existing videos. Such Web Sites 108 are well known, and include those which provide functionality similar to YouTube® or other social networking sites allowing users to post UGC.

In various embodiments, an additional source of video clips that are posted on the Web Site 108 may originate from the VOD system 100. In this case, the video clips may not be user generated content because the content is not produced by the user, but professionally produced content that is identified by users. For instance, in various embodiments, subscribers of a VOD service are provided with a mechanism to tag segments of video that are available in the VOD system 100. Such a mechanism is detailed in U.S. patent application Ser. No. 12/347,430 filed on Dec. 31, 2008 and entitled “Systems, Methods, and Apparatus for Tagging Segments of Media Content,” which is incorporated herein by reference in its entirety.

Thus, these segments of videos may be made available from the VOD system 100 to the Web Site 108 for review by users of the Web Site 108. For example, in various embodiments, at the time a subscriber tags a particular segment of a video, the subscriber may indicate to make the segment available on the Web Site 108 for review. In one embodiment, pointers to the location of the segment in the original video along with a description (e.g., caption) of the segment are posted on the Web Site 108. A visitor to the Web Site 108 may request to review the segment and the Web Site 108 may retrieve the segment from the original video by using the pointers. In another embodiment, the segment, itself, is stored along with the other video clips uploaded to the Web Site 108.

In addition to posting and viewing video, the Web Site 108 may allow users to recommend, vote, or otherwise provide feedback regarding a particular video. In particular, the Web Site 108 typically does not only provide the video itself for viewing to a user, but also receives feedback from viewers as to their opinions on a particular video. The Web Site 108 may also maintain or generate data regarding how popular is a particular video, such as how many times the video has been downloaded in a given time period, or how many times it has been downloaded during its availability. As used herein, “downloaded” can be equated to being selected and/or viewed by the user. The Web Site 108 may also provide a rating system, such as, for example, a numerical scale from 1 to 5 (indicated by an icon, such as a star) which the viewer can provide as input after viewing the video. Various metrics can be defined by which the Web Site 108 uses to determine a list of popular videos. Alternatively, the Web Site 108 may provide viewing data, feedback data, or other information from which the popularity of a video can be derived. In other embodiments, the Web Site 108 may word search viewer feedback by word spotting or other algorithms as input to rank the video. Provided below are further details of the various user capabilities provided on the Web Site 108.

Periodically, the APS 106 will obtain data from the Web Site 108 as to the popularity of videos posted to the Web Site 108. This information (termed “popularity data”) can be “pulled” by the APS 106 requesting the data periodically, or “pushed” by the Web Site 108 to the APS 106. The period for which popularity data if provided can be defined by a system administrator in the APS 106 as appropriate. For example, this information can be obtained, daily, weekly, or for some other time period. Further, the popularity data obtained pertaining to a set of videos can be unfiltered users' feedback, such as rating information, or an aggregate popularity data index, or a combination of both. In various embodiments, the aggregate popularity can be determined by the Web Site 108, the APS 106, or by a combination of both.

In another embodiment, it is possible to send not only the data pertaining to popularity of videos posted on the Web Site 108, but also the video themselves. In this embodiment, the APS 106 may accept the videos as those which should be placed in the VOD system 100. Alternatively, the APS 106 may further reduce the number of videos by processing the popularity data to arrive at a subset of the videos which should be placed in the VOD system 100.

In one embodiment, the Web Site 108 makes available initially only the popularity data, and the APS 106 processes this data to determine the set of videos to place in the VOD system 100. However, as will be seen in another embodiment, the uploaded video information may be stored in the same storage system that stores the VOD videos. The APS 106 may process the popularity data in various ways, and the algorithm used can vary. For example, the APS 106 may select the top 5% videos in terms of popularity (regardless of how this metric is defined) and further cap the number of videos to a maximum number during a certain time period. Thus, the APS 106 may derive the top 5% most popular videos for a given week, wherein the number does not exceed 10 videos.

Thus, in one embodiment, the APS 106 determines a list of videos stored in the Web Site 108 which it requests from the Web Site 108. The APS 106 typically initiates a request for the videos, identifying the videos with an identifier provided to the APS 106 by the Web Site 108. Recall that the Web Site 108 provides popularity data to the APS 106 and the data references a particular video using a video identifier. Thus, the APS 106 may request copies of the videos by referencing the video identifier.

The Web Site 108 makes available the requested videos to the APS 106. Typically, the format of the video stored in the Web Site 108 is converted into a format compatible with various Internet browsers (“Internet Viewing Format”), such as a “FLASH®” format. Thus, the format may be changed by the Web Site 108 from the format of the video when it was initially received, such as MP3 or a WMV file format to a format suitable for Internet viewing. Typically, the Web Site 108 provides the video formats to the APS 106 in the same format that the video is stored (whether it is in the original or Internet Viewing format). However, in other embodiments, the Web Site 108 may convert the video clip to a format used by the APS 106, such as MPEG.

In another embodiment, as shown in FIG. 1b, the APS and the Video Uploading/Viewing Web Server are combined into a single system 156, called hereafter an “Integrated APS.” In this embodiment, the system receiving the uploaded video also is the same system that determines the most popular videos. Thus, there is no requirement to pull, push, or otherwise transfer information between two separate systems. This facilitates various aspects of the system operation, as will be seen below. Hence, hereafter, the System's operation will be discussed in light of FIG. 1b.

The Integrated APS 156 also maintains a database 107, which stores, among other things,
a. User profile data,
b. Information about the Video clip information,
c. System parameter information, and
d. User feedback.
   In various embodiments, the database 107 may or may not store the video clips themselves. Typically, in embodiments where separate APS and Web Site systems are involved, the Web Site stores an Internet Viewing Format copy of the video clip.

In both embodiments of FIG. 1a and FIG. 1b, there is a system administrator input/output device, such as a terminal or a personal computer 111, which allows a system administrator (“Administrator”) to configure various parameters, provide input for the system operation, and perform other functions as are described below. The Administrator can either have direct access to the Integrated APS 156, or access it remotely via a network, such as the Internet.

The video clips uploaded by a user at computer 112a, 112b are typically received in a format that needs to be transcoded by the Integrated APS 156. Because the videos on the Integrated APS 156 (or the Web Server 108) are intended to be viewed by subsequent users, the video clips are transcoded into a format suitable for viewing by other Internet users, which may include, for example, a H.264 QuickTime format with AC3, AAC, or MPEG based audio. Other formats, such as “FLASH®”, may be used. In one embodiment, the transcoding is performed by the transcoder system 109, which is illustrated as a separate system from the Integrated APS 156. In other embodiments, the transcoder system 109 functionality can be incorporated into the Integrated APS 156. The transcoder system 109 typically receives a file in one format, and generates a video file in another format. In some embodiments, the transcoder system 109 can communicate with the VOD system 100, 150, whereas in other embodiments, the transcoder system 109 only communicates with the APS 106 or Integrated APS system 156. The following formats are typically supported by the transcoder system 109:
a. Input formats:
   i. mpg,
   ii. Quicktime®
   iii. Windows® media video
   iv. Audio Video Interleace (“AVI”)
   v. MPEG2,
   vi. MPEG4
   vii. 3GP
   viii. H.264
   ix. or other readily available consumer video formats used to upload video to a web site;
b. Output formats:
   i. AVI,
   ii. H.264 QuickTime® HD and SD formats with AC3, AAC or MPEG audio,
   iii. Or other readily available format used for viewing videos at a web site.

The transcoder system 109 also functions to transcode the uploaded video into a format that is compatible with the VOD system 150. Thus, any of the above formats may be converted to:
i. CableLabs® MPEG2 Transport SD (required),
ii. CableLabs® MPEG2 Transport HD,
iii. H.264 Transport SD with MPEG audio or AAC audio,
iv. H.264 Transport HD with AAC audio
v. H.264 web format with AAC audio, or
vi. Any other format use in a cable distribution system.
   There are typically two instances of formatting that occur from when the Web Site receive a video clip to when the video is placed in a VOD system. Typically, the video received from a user via the Internet is transcoded (e.g., it may be received in a MP3 file format and may be converted to a QuickTime® format). Then, the same file, when placed in the VOD system 150, may be transcoded (e.g., it is formatted from a Quicktime® format into a MPEG format).

A video content storage system 152 may be used to store the video files in their various forms. The video content storage 152 in the embodiment shown in FIG. 1b can store the same video file in various coded forms. Namely, the original file format as uploaded by the user, the file format used by the Web Site interface of the Integrated APS 156 for allowing viewers to view the video, and another format used by the VOD system 150 for compatibility with cable transmission systems equipment. In other embodiments, such as shown in FIG. 1a, the Video Uploading/Viewing Web Server 108 may have its own local storage comprising the original file format, and the Internet Viewing Format. In either embodiment, it is not necessary for the original file format to be retained after the Internet Viewing Format is created.

In the embodiment of FIG. 1b, the transcoder system 109 is able to support function calls wherein the originator (e.g., the Integrated APS system 156) indicates the file name and location and the requested file format. In one embodiment, the transcoder system 109 is then able to access the video content storage 152, transcode the file as requested, store the result in the video content storage 152, and inform the requesting entity that the request has been processed. In other embodiments, the transcoder system 109 does not transfer files directly to/from the VOD system 100, 150, but transfers information via the APS 106 or the Integrated APS 156. Thus, a user located at a computer 112a may upload a video which is stored in the video content storage 152, and the Integrated APS 156 then initiates a function call to the transcoder system 109 to encode the indicated file into an Internet Viewing Format. Once completed, the transcoder system 109 then informs the Integrated APS 156 that the task is completed. Then, once the Integrated APS 156 subsequently determines that the video clip is “popular” and is to be placed in the VOD system 150, the Integrated APS 156 requests the transcoder system 109 to encode the file into an MPEG format. This can be converted into MPEG either from the original file format (if saved) or the Internet Viewing Format.

The APS initiates the placement of the video clips into the VOD system. The VOD system 150, which comprises a processor 104, in one embodiment is able to directly access the video content storage 152 and process VOD requests. In other embodiments, the VOD system 150 accesses the video content storage system 152 indirectly, via the Integrated APS 156. The VOD system 150 streams the selected video clip over a cable headend 114 that multiplexes various video streams in digital form over a cable distribution network 116 to the user's set top boxes 120a, 120b. Although a typical Hybrid Fiber Coax (“HFC”) cable distribution network is shown, an IPTV, wireless, or other type of video distribution technology could be used. The distribution of the video clip to a cable subscriber presumes that the video clip has been loaded into the VOD system 150 and that the video clip has been determined to be popular enough to warrant doing so.

Thus, once the video clips are placed in the VOD system, these video clips may be viewed by any subscriber of the VOD service or used for other purposes within the VOD system 150. For instance, in one embodiment, these video clips may be accessed and used in a video sharing community in the cable system. A mechanism for providing such a community is detailed in U.S. patent application Ser. No. 12/408,831 filed on Mar. 23, 2009 and entitled “Video Sharing Communities in a Cable System,” which is incorporated herein by reference in its entirety.

For instance, in various embodiments, the cable service provider may provide a social networking service that involves sharing information pertaining to a common video program with a group within the cable system called a Community Group (“CG”). Users of the Community Group are “members” and the information shared among members can be in various forms, including text and/or video clips. In addition, the social networking service allows the user to also enter commentary with the video clips. Thus, the social network service allows users to utilize the uploaded video clips to share with a CG that may or may not include commentary.

In addition, it is possible that a user located at computer 112a may upload a video to the Web Site 108 on the Integrated APS 156, and if selected as a popular video, the same video may be selected for viewing over the VOD server by the same user using his or her set top box 120a. Thus, it is possible that the computer 112a and the set top box 120a are operated by the same user and both are located in the same household. Further, it is possible that the user's computer 112a may access the Internet using a cable high speed data service provided by the cable service provider. However, in many instances a different user at another set top box 120b will download user generated content for viewing. Thus, there is no requirement that the user downloading a VOD video be the same user that ultimately originated the video.

FIG. 1c illustrates embodiments of various configurations of the present invention within one or more video service providers' systems (e.g., a cable provider's system and/or a wireless provider's system). The present invention is able to interact with a variety of video service provider types, including cellular service, fixed wireless, wireline based on IPTV, hybrid fiber coax, or other technologies. The particular embodiments shown in FIG. 1c incorporate the Integrated APS 156 for illustrative purposes only. However, it should be understood that other configurations of the APS (such as the APS 106 shown in FIG. 1a) may be used in accordance with the various systems shown in FIG. 1c in other embodiments.

As previously described, the Integrated APS 156 may gather video clips from various sources and provide clips to various video service providers. For instance, Internet based users may upload video clips over the Internet 110 as well as view uploaded video clips by visiting the Web Site incorporated with the Integrated APS 156. In various embodiments, the Integrated APS 156 includes a web interface and hosts the web site. In other embodiments, the Integrated APS 156 may also communicates with other web servers that host the web site also provide videos.

In addition, various users may upload video clips to the Integrated APS 156 and view uploaded video clips through other channels. Further, users may upload still images in addition to video clips. For instance, in one embodiment, users may upload video clips or digital pictures to the Integrated APS 156 via a cell phone 180b. In this particular embodiment, the user may take a photograph or record a video on his or her cell phone 180b, access the web site in communication with the Integrated APS 156 on his or her cell phone 180b, and then upload the photograph or video clip to the Integrated APS 156. In addition, users may view uploaded videos or images on their cell phones 180a by accessing the Web Site via an Internet browser provided on their phone or the users' wireless provider 170. An application loaded into the mobile phone may provide a listing of the video clips that can be viewed on the user's phone 180a.

Furthermore, subscribers to a cable provider may upload video clips to the Integrated APS 156 and view video clips. For instance, a subscriber 113a may be located within a particular cable distribution network 116a associated with a particular headend 114a of a cable system provider 160. This particular subscriber 113a may view video clips provided by the subscriber's cable system provider 160a through the subscriber's set top box 120a. In addition, the subscriber 114a may also have a computer 112b connected to the Internet 110 and may upload video clips to the Integrated APS 156 through the Web Site. Another subscriber 113b may be located within a different cable distribution network 116b associated with a different headend 114b of the cable system provider 160a. This particular subscriber 113b may have both cable service and Internet service (e.g., via a cable modem) through the cable system provider 160a. Therefore, this particular subscriber 113b may view videos through the subscriber's set top box 120b and may upload videos to the Integrated APS 156 through the subscriber's computer 112c over the cable system provider's 160a cable distribution network 116b.

Thus, in various embodiments, the Integrated APS 156 may service a cable system provider 160a with multiple headends 114a, 114b. In these particular embodiments, the Integrated APS 156 may provide different sets of video clips to the various headends 114a, 114b of the cable system provider 160a. For instance, the first headend 114a may be servicing an area in Texas and the second headend 114b may be servicing an area in California. Therefore, when a user uploads a video to the Integrated APS 156 (and/or rates a video), the user may indicate which cable distribution network 116a, 116b (and/or which headend 114a, 114b) the user is associated with. In turn, the Integrated APS 156 may provide the first headend 114a with a “most popular” set of video clips that are available on the headend's 114a associated VOD system and provide the second headend 114b with a second “most popular” set of video clips that are available on the headend's 114b associated VOD system. Therefore, the list of video clips made available to the subscribers 113a associated with the headend 114a servicing Texas may be different than the list of video clips made available to the subscribers 113b associated with the headend 114b servicing California. As a result, the lists of video clips may be made available to subscribers 113a, 113b on different cable distribution networks 116a, 116b that are more consistent with the subscriber's 113a, 113b interest. For example, the subscribers associated with the headend 114a servicing Texas may be more interested in seeing video clips of weekly high school football games or of a recent event that occurred in Texas such as the state fair. In contrast, the subscribers associated with the headend 114b servicing California may be more interested in seeing video clips of the ocean along the California shoreline or of various parts of the California wine country.

The video clips provided to a VOD service may be stored and provided differently according to various embodiments. For instance, in one embodiment, the Integrated APS 156 provides the list of video clips to the VOD system 150 of a cable system provider 160b and provides the videos to the VOD system 150 for storage within the cable system provider's 160b system. Thus, when a subscriber request a particular video clip to view, the VOD system 150 retrieves the video clip from storage within the cable system provider's 160b system and streams the video through the headend 114c of the cable system provider 160b over the cable distribution network 116c to the subscriber's set top box 120c.

In another embodiment, the Integrated APS 156 may store the video clips locally in storage medium 190 and provide the VOD system 150 of the cable system provider 160b with a listing of the available video clips. In this particular embodiment, when a subscriber requests to view a particular video clip from the listing, the VOD system 150 requests the video clip from the Integrated APS 156 and the Integrated APS 156 retrieves the video clip from the content storage 190 and delivers the video clip to the VOD system 150. The VOD system 150 then streams the video clip through the headend 114c of the cable system provider 160b and over the cable distribution network 116c to the subscriber's set top box 120c. Thus, in this particular embodiment, the cable system provider 160b is not required to provide storage for the video clips. Thus, it should be understood that the term “provide” means to transmit the video clips to the VOD system 150 and also means to make the video clips available to the VOD system 150.

Furthermore, in this particular embodiment, the Integrated APS 156 may stored the video clips in one format in the content storage 190 or may store the video clips in several different formats in the content storage 190. For instance, the Integrated APS 156 may provide the video clips to several different providers that require the video clips in different formats. For example, the Integrated APS 156 may provide the video clips to the cable system provider 160b and a wireless system provider 170 (such as a cell phone provider). In this particular embodiment, the cable system provider 160b may need the video clips to be provided in an MPEG format and the wireless system provider 170 may need the video clips to be provided in a MP3 format. Thus, the Integrated APS 156 may store a first version of the video clips in a MPEG format and a second version of the video clips in a MP3 format.

In another embodiment, the Integrated APS 156 may store the video clips in only one format and may include a transcoder system that transcodes the requested video clip to the proper format before forwarding the clip to the requesting provider. Thus, in the example, the Integrated APS 156 transcodes the video clips requested by the cable system provider 160a to a MPEG format before forwarding the clips to the cable system provider 160a and transcodes the video clips requested by the wireless system provider 170 to a MP3 format before forwarding the clips to the wireless system provider 170. Yet in another embodiment, the providers 160b, 170 may have their own transcoder systems and the Integrated APS 156 provides the video clips in the same format to each provider 160b, 170 and the provider 160b, 170 transcodes the video clips to their required format via their own transcoder systems.

Lastly, it should be appreciated by one of ordinary skill in the art that the Integrated APS 156 may be included in a service provider system or may be a stand-alone system that services several different service provider systems according to various embodiments. That is, the Integrated APS 156 may be included in the cable system provider's 160a system and only provide video clips to the particular cable system provider's 160a system. Furthermore, the web site on which users upload video clips may also be included in the cable system provider 160a. While in other embodiments, the Integrated APS 156 may be a stand-alone system that services several providers, such as cable system providers 160a, 160b and wireless service providers 170.

### Exemplary Integrated APS Architecture

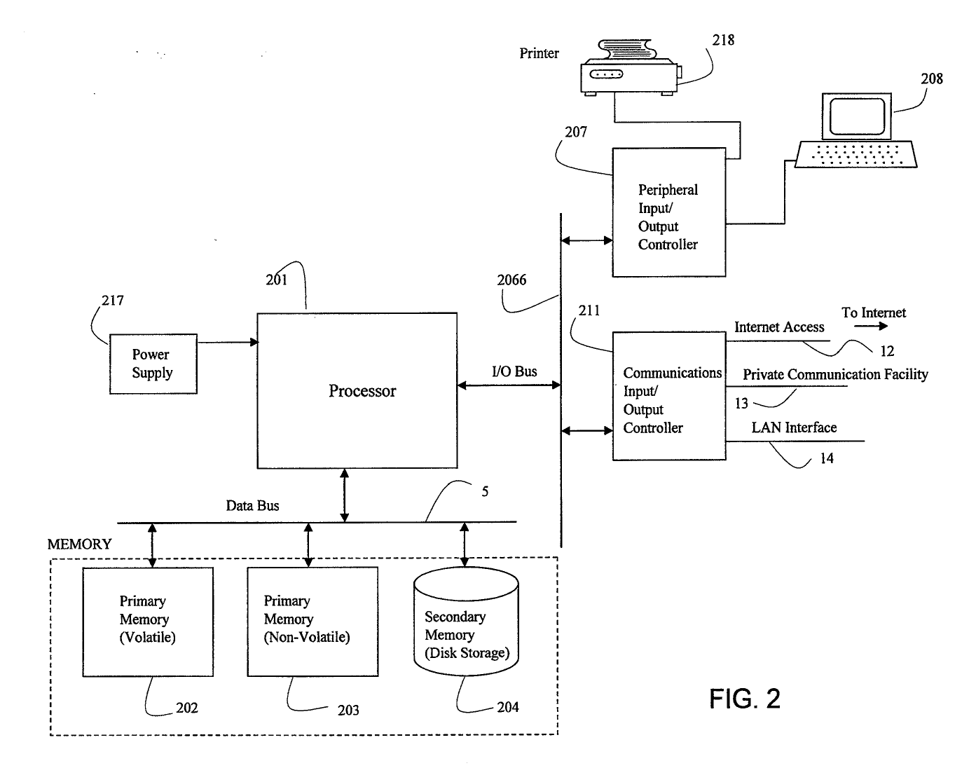

FIG. 2 shows a schematic diagram of an Asset Placement System (“APS”) according to one embodiment of the invention. It should be appreciated that in various embodiments that include a web server, the web server may have a similar structure as described below in regard to the APS. For example, the APS can operate on one computer or on multiple computers that are networked together or otherwise function in a distributed manner.

In this particular embodiment, the APS includes a processor 201 (and power supply 217) that communicates with other elements within the APS via a system interface or bus (e.g., data bus 5 and/or I/O bus 2066). Also included in the APS is a display device/input device 208 for receiving and displaying data. This display device/input device 208 may be, for example, a keyboard or pointing device that is used in combination with a monitor by the Administrator, for example, to communicate with the APS (e.g., provide information for various videos uploaded) and to monitor the APS. In addition, in various embodiments, the display device/input device 208 may communicate through a peripheral input/output controller 207 with other components (such as the processor 201) of the APS. Furthermore, in various embodiments, the APS may include an output device 218 such as a printer. This device 218 may also communicate with other components of the APS through the peripheral input/output controller 207.

The APS further includes memory, which preferably includes primary memory and secondary memory. The primary memory includes both volatile memory 202, such as random access memory (RAM), and non-volatile memory 203, such as read only memory (ROM). The APS's non-volatile primary memory 203 may be used to store a basic input/output system (BIOS), containing the basic routines that help to transfer information between components within the APS.

In addition, the secondary memory 204 may include a storage device, such as hard disk storage, floppy disk storage, a CD Rom drive, a flash drive, or an optical disk drive, for storing information on various computer-readable media, such as a hard disk, a removable magnetic disk, or a CD-ROM disk. As will be appreciated by one of ordinary skill in the art, the secondary memory 204 is connected to the data bus 5 by an appropriate interface. The secondary memory 204 and associated computer-readable media provide non-volatile storage for the APS. It is important to note that the computer-readable media described above could be replaced by any other type of computer-readable media known in the art. Such media include, for example, magnetic cassettes, flash memory cards, digital video disks, and Bernoulli cartridges.

Also located within the APS is a communications input/output controller 211 that provides an interface for communicating with other elements of one or more networks, such as the Internet 12, a private communication facility 13, and/or LAN 14. It will be appreciated by one of ordinary skill in the art that one or more of the APS's components may be located geographically remotely from other APS components. Furthermore, one or more of the components may be combined, and additional components performing functions described herein may be included in the APS.

### Exemplary User Functions on Web Site

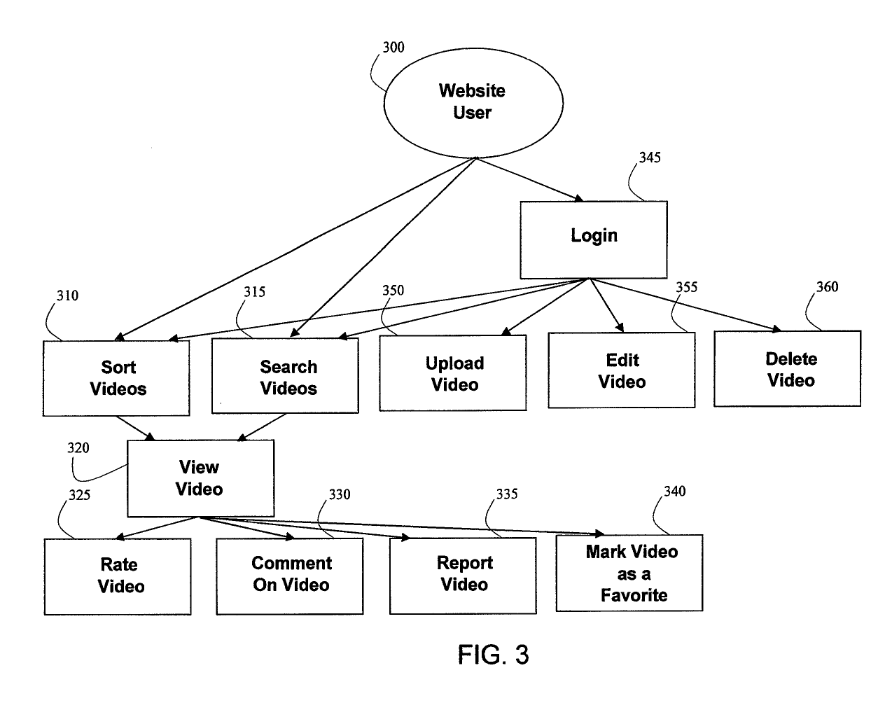

As previously described, the Web Site 108 provides several user capabilities according to various embodiments. A process 300 for performing user functions on the Web Site 108 according to one embodiment is shown in FIG. 3. In this particular embodiment, a user may visit the Web Site 108 to perform some function on the Web Site 108 such as view one or more video clips and/or to upload one or more video clips. In a particular embodiment, the user is first presented with a “home screen” upon visiting the Web Site 108.

In one instance, the user may perform functions on the Web Site 108 anonymously, bypassing the login or registration process. For example, in Step 310, the user may sort videos according to various criteria such as ratings the videos have received from previous viewers, the popularity of the videos (e.g., how many times a particular video have been viewed), or the newness of the videos. In one embodiment, the criteria may be selected via icons on the screen that represent each of the available criteria for sorting. The user simply clicks on the icon for the desired criteria and the videos are rearranged according to the selection.

Alternatively, the user can search for a video using various criteria, shown as Step 315. For instance, in one embodiment, the user can perform a simple search for keywords in videos' titles. For example, the user is provided with a text box (e.g., search bar) that the user can type in the word or words for searching and the user selects a “Search” button to perform the search. In one embodiment, the Web Site 108 provides a function that allows the user to perform a more advanced search. In this particular embodiment, the user clicks the “advanced search” button associated with the search bar and he or she is taken to a search page. From this page, the user can search for one or more words found in a video title or description, as well as look for videos by a particular user, or filter the results to only include the user's friends' videos or favorite videos. Finally, in various embodiments, the user may sort the search results by relevance, popularity, or other metrics.

Once the user has found a suitable video to review, in one embodiment, the user selects an icon corresponding to the video that results in presenting a page providing further information about the video. This page displays statistics regarding the video, as well as comments and ratings associated with the video, along with controls for viewing the video itself. Thus, the user can view the video as shown in Step 320 by controlling a virtual video player.

In one particular embodiment, the user can pause the playing of a video by selecting the appropriate function of the video player. The user can then resume playing the video by selecting the function a second time in the video player. In addition, the user can move the mouse over the bottom of the video player to reveal the video time line. This allows the user to jump to any portion of the video. The user accomplishes this by simply clicking the appropriate section of the time line to have the video begin playing from the section of the time line. In a similar manner, sound may also be adjusted according to personal preferences by manipulating the sound bar.

In various embodiments, once the user has reviewed the video, the user may provide feedback about the video. For instance, the user may wish to submit a rating for the video, shown as Step 325. In one embodiment, five stars are lined up in a row underneath the video. In this particular embodiment, the number of highlighted stars corresponds to the video's rating, with five out of five stars considered the best rating. To rate a video, the user moves his or her mouse over a star and this causes the star and all preceding stars to be highlighted. The user then clicks the star to submit a rating for the video corresponding to how many stars are currently highlighted. In various embodiments, this rating will be factored in along with all other ratings to calculate the video's overall average rating. In addition, in various embodiments, a record of the user's rating (associated with “Anonymous” if the user has not logged in) is generated and stored.

In addition, in various embodiments, the user may also wish to leave a comment along with his or her rating, shown as Step 330. In these particular embodiments, the user may also just leave a comment without providing a rating. In one particular embodiment, the user writes a comment in a comment text box provided below the five stars. In this particular embodiment, once the user has entered his or her comment, the user selects a “Comment and Rate” button to submit the rating and comment.

In various embodiments, the user is required to register with the Web Site 108 to upload videos. Thus, in these particular embodiments, the user creates a User Account. For instance, in one embodiment, the user creates a User Account by clicking the “sign up” button located on the home screen, which takes the user to a sign up screen. Once at the sign up screen, the user completes the provided form on the screen. In one embodiment, the creation of the account is rejected if the login or e-mail provided by the user is already taken, if the password provided by the user is less than a predetermined number of characters, or if the password confirmation does not match the password provided by the user.

Furthermore, in particular embodiments, the user provides information that allows selection of the cable system (e.g., headend) associated with the user. Typically, this information is based on the location and/or other information provided by the user. This allows the APS 106, 156 to associate the user with a particular cable provider so that the appropriate VOD equipment can be selected, thus allowing the video to be available to the user through the user's VOD service.

Thus, in various embodiments upon returning to the Web Site 108, the user will login on the home screen and the Web Site 108 (e.g., APS or web server) will retrieve information about the user to use during the user's session on the Web Site 108, shown as Step 345. In particular embodiments, the user can confirm that the Web Site 108 has correctly identified the user by looking at a message stating “Welcome, [Account Name]”, wherein the user's login is displayed in place of [Account Name].

In various embodiments, once the user has logged into the Web Site 108, the user can perform the functions as described above and one or more additional functions. For instance, in Step 350, the user can upload videos to post on the Web Site 108. In one particular embodiment, the user uploads a video by clicking the “Upload Video” link on a navigational toolbar to bring up an “upload screen.” After viewing the upload screen, the user may name the uploaded video, as well as provide a description for it. The user clicks the “Browse” button to allow the user to select any video file on the user's computer. Furthermore, in various embodiments, the user may provide a thumbnail. In these particular embodiments, if the user does not provide a thumbnail, the Web Site 108 may attempt to automatically generate an image from the video to use as a thumbnail. The user clicks the “Upload” button to upload the video to the Web Site 108. Once the video is uploaded, the Web Site 108 in various embodiments may automatically transcode the video to another format such as FLASH® so that the video can be view on the Web Site 108.

In various embodiments, in order for a user to be able to edit a video, the user typically must be the video's originator (that is, the user must have uploaded the video to the Web Site 108). The user can edit a video by clicking the “edit” button to bring up an edit screen, shown as Step 355. Once at the edit screen, the user can rename the video, provide the video a new description, or choose a new thumbnail for the video. In one embodiment, six automatically generated thumbnails are provided for the user to choose from for selection as the thumbnail to be used by the System. In addition, in one embodiment, the user can click the “upload” button and upload a user generated image to use as a thumbnail for the video.

Furthermore, in various embodiments, the user can delete a video from the Web Site 108, shown as Step 360. As is the case with editing a video, in various embodiments, a user typically must be the video's originator in order to be able to delete the video. In one particular embodiment, the user clicks the “delete” button while viewing a video. The Web Site 108 asks the user for confirmation, and upon confirmation the Web Site 108 deletes the video.

With respect to functions that may be performed regarding uploaded videos, in various embodiments, a user that has logged into the Web Site 108 may perform additional functions from those functions that an anonymous user may perform. For instance, in one embodiment, the user may “report” a video, shown as Step 335. Thus, in this particular embodiment, a user may identify a video the user considers inappropriate on the Web Site 108. The user reports the inappropriate video by clicking a button, such as a “Report This Video” button provided along with the video player used to play the videos. In various embodiments, the user may also provide a comment along with the report. In various embodiments, the submitted reports are reviewed by the Administrator who makes a decision based on the report as to whether the video should be removed from the Web Site 108.

Furthermore, in various embodiments, users who have logged into the Web Site 108 may identify selected videos as “favorites,” as shown in Step 340. In these particular embodiments, the Web Site 108 may save a listing of the user's favorite videos to facilitate retrieval of desired corresponding videos from the list.

In one particular embodiment, to mark a video as a favorite, the user clicks the “Favorite” button along with the video player (when viewing a video). This action adds the video to the user's list of favorite videos. In one embodiment, the list is displayed along with the user's profile and can be viewed from a “Favorite Videos” link provided on the home screen when the user logs into the Web Site 108.

As previously mentioned, various embodiments also include the capability allowing an Administrator to access the System to perform various functions (e.g., administrative duties) within the system. Thus, in various embodiments, the Administrator may be associated with an administrator user account that the Administrator may use to log into the Web Site 108 to perform administrative duties. Some of these administrative duties may include configuring the Web Site 108, configuring headends within the system, managing content (e.g., metadata of videos, listings of videos, user accounts, headend information, etc.) and viewing video reports.

For instance, from an administration screen, the Administrator can configure default fields for metadata, as well as set the IP addresses of various critical components for the Web Site 108. In various embodiments, these fields may automatically be included in all packages (e.g., video content bundled with associated information) uploaded to the cable provider's VOD system. In addition, the Administrator can view videos associated with a particular headend, create a new headend within the system, edit an existing headend, and delete an existing headend from the system. Furthermore, in various embodiments, the Administrator can view packages for a particular headend and associated content and information for the packages. The Administrator can also create new packages for a particular headend, generating the metadata for one or more packages, and delete a particular package.

Finally, in various embodiments, the Administrator can review the video reports generated by users. In particular embodiments, the Administrator is provided with a screen that displays a list of videos, sorted based on the number of reports received for the videos. In one embodiment, the Administrator is also provided with a mechanism to delete videos from this screen.

### Exemplary Workflow

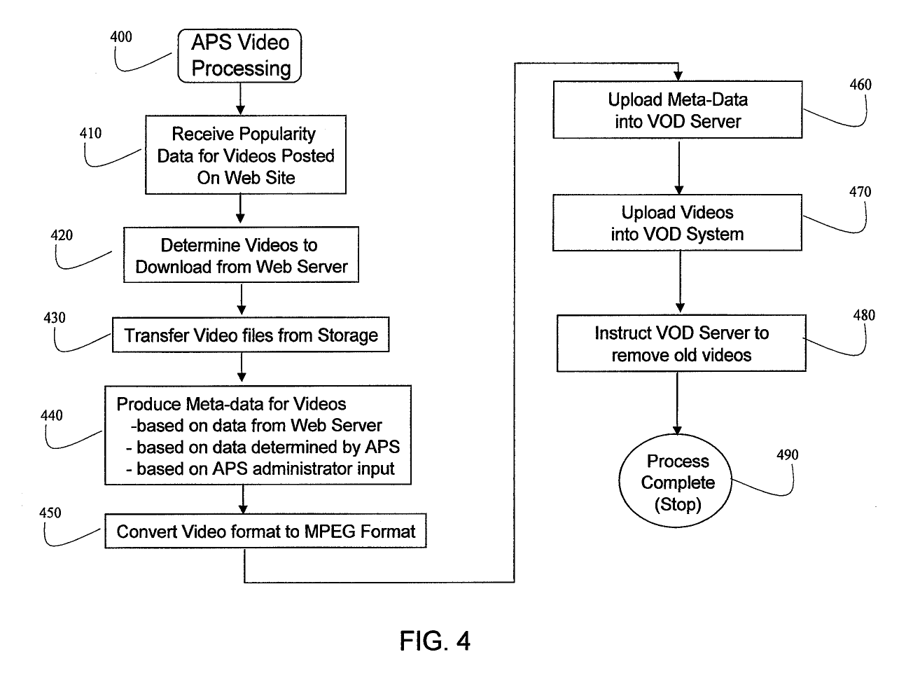

A process 400 for uploading videos from the APS 106 (or Integrated APS 156, henceforth referred to as “APS 106, 156”) to the VOD system 100, 150 according to one embodiment of the invention is shown in FIG. 4. The process 400 begins with the APS 106, 156 (and/or Web Site 108) receiving popularity data for videos posted to the Web Site 108, shown as Step 410. As previously described, the APS 106, 156 is designed to receive user feedback on videos post to the Web Site 108. The APS 106, 156 then generates and/or maintains data regarding how popular a particular video is considered by users (e.g., viewers). For instance, the APS 106, 156 generates and/or maintains data that indicates how many times the video has been reviewed while posted on the Web Site 108 and/or the average rating received for each video posted on the Web Site 108.

In Step 420, the process 400 continues with the APS or Web Site determining from the popularity data which of the videos posted on the Web Site 108 should be placed in the VOD system 100, 150. For example, in one embodiment, the APS 106, 156 may select the top 5% of the videos reviewed on the Web Site 108. In another embodiment, the APS 106, 156 may select the top 25 videos reviewed on the Web Site 108. Thus, the APS 106, 156 derives a list of videos that are to be placed in the VOD system 100, 150.

In Step 430, the selected videos may be transferred from storage. For instance, in the system depicted in FIG. 1a, the Web Site 108 may store videos uploaded to the Web Site 108 to a storage device local to the Web Site 108 in an Internet Viewing Format. Thus, in this particular embodiment of the system, the APS 106 transfers the selected videos to be uploaded to the VOD system 100 from the Web Site's 108 storage to the APS 106. However, in the system depicted in FIG. 1b, the APS and the Web Site are combined (e.g., Integrated APS 156) into a single system and the Integrated APS 156 may share storage along with the VOD system 150. Therefore, in this particular embodiment, the Integrated APS 156 does not need to perform the step of transferring the selected videos from the web server's storage as it merely needs to know the file location identifiers in order to access the video files. Thus, placing a video to the VOD server may involve transferring the video file itself or transferring location identifiers of the video file.

Continuing with the process 400, metadata is produced for the selected videos from one or more various sources of information, shown as Step 440. For instance, in various embodiments, the APS 106, 156 stores information gathered from the user who is uploading the video to the Web Site 108 at the time of uploading and information from the video, itself, to store in a database 107. For example, at the time of upload, the user may provide a title for the video, a caption for the video, the headend the user is associated with, and/or a category the video may fall under such as funny home video or sporting event video. In addition, the APS 106, 156 may store the user's identification and/or login so that the uploaded video can be linked to the individual who uploaded the video to the Web Site 108.

The APS 106, 156 may also store information that is generated by the APS 106, 156. For instance, the APS 106, 156 may convert the uploaded video into another format that allows other Internet users to access and view the video (so that the video may be reviewed on the Web Site 108) before storing the video and the APS 106, 156 may store information in the database on the current format of the video.

Furthermore, the Administrator may provide information that is stored in the database 107 and that is used by the System to generate metadata. For instance, the Administrator may store default values in the database 107 for certain metadata fields, such information as a preview period for how long the video is to remain available in the VOD system and a viewer rating for the video. In various embodiments, the Administrator may also edit this retrieved information from the database before the video is placed into the VOD system 100, 150. For example, the default value for viewer rating may be set at “PG-13.” However, the Administrator may review the videos before they are uploaded into the VOD system 100, 150 or videos may be flagged based on viewers' comments and based on the Administrator's review and/or comments, the Administrator may change the viewer rating to “R.”

In summary, the APS 106, 156 (whether the integrated or non-integrated embodiment) creates metadata for each video clip based on three potential sources of information. First, the input provided by the user (e.g., title, user_id) is used to create certain metadata fields. Second, information is produced by the APS 106, 156 based on processing the video clip is used to create other metadata fields. For example, when converting a video clip to a VOD server compatible format (e.g., MPEG 2 in Standard Definition format), the system may use that information to populate the “format” identifier in the metadata. Other parameters may be determined by the processing of the video clip itself. Third and finally, the APS 106, 156 may use certain parameters that are fixed to a default value by the Administrator to create other metadata fields. For example, the rating field of the metadata may be determined by a default value selected by the Administrator.

Examples of metadata that are included along with a video clip in various embodiments include: (1) a unique identifier for the provider of the video clip; (2) an identifier for the product offering; (3) a string identifying the name of the video clip; (4) a human-readable string describing the video clip; (5) a string representing the date on which the video clip was created; (6) audio types available for this video clip; (7) the screen format (e.g., Standard, Widescreen, and Letterbox) for the video clip; (8) the available languages for the video clip; (9) an indicator of whether the video clip is copyright protected; and (10) the file size of the video clip. A listing of various metadata fields that may be generated by the System is found in Metadata Specifications: CableLabs® VOD Content Specification Version 1.1, MD-SP-VOD-CONTENT1.1-105-060831, Aug. 31, 2006, the contents of which are incorporated by reference.

In Step 450, the process 400 continues with converting the selected videos to a format compatible with the VOD system 100, 150. For example, in various embodiments, the APS 106, 156 transcodes the selected videos from their current format to MPEG format by instructing the transcoder system 109 (e.g., executing a function call) to perform the transcoding process. Thus, the selected videos are made available to the VOD system 100, 150 in a suitable format for use by the VOD system 100, 150.

The process 400 continues with the APS 106, 156 making available the corresponding package comprising the video content and metadata for each video, shown as Steps 460 and 470. In various embodiments, a package includes one or more assets. In many embodiments, these packages and corresponding assets may conform to the aforementioned CableLabs® Metadata Specifications.

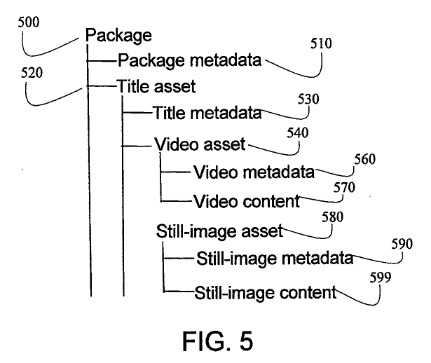

An example of a structure of one such package 500 is shown in FIG. 5 according to one embodiment. In the particular embodiment shown in FIG. 5, the package 500 structure includes a title asset 520, a video asset 540, and a still-image asset 580. In various embodiments, an asset 520, 540, 580 may include both metadata and/or content. For instance, in the embodiment shown in FIG. 5, the video asset 540 includes both video content 570 and metadata 560.

In the package 500 structure shown in FIG. 5, the package 500 includes corresponding metadata 510 that provides the information necessary to place the video on a VOD server. For instance, the package metadata 510 in one particular embodiment includes such information as:
a. The provider of the video,
b. An identifier for the product offering,
c. A string containing the identifying name of the video,
d. An integer representing the major version number,
e. An integer representing the minor version number,
f. A human-readable string describing the video,
g. A string representing the date on which the video was created (e.g., was uploaded to the Web Site 108),
h. A unique identifier for the provider of the video, such as a registered Internet domain name belonging to the provider,
i. An identifier for the video that is unique within the provider's video ID space, and
j. A system-level type for the video that is intended to help map and route the video in the VOD system.

In the embodiment of the package 500 structure shown in FIG. 5, the title asset 520 includes title metadata 530. In one particular embodiment, the title metadata 530 may include additional information such as the title of the video and a brief version of the title that may be used to display on a screen in the VOD service. For instance, the title metadata 530 in one particular embodiment includes information similar to the package metadata 510 such as the provider of the video, the identifier for the product offering, the string containing the identifying name of the video, the major version number, and the minor version number. Furthermore, the title metadata 530 may include additional information such as:
a. The content type that determines how or where the content is stored,
b. An string to be used when sorting the title,
c. A sting representing a period of time and the maximum number of views over the period of time,
d. The video title,
e. A summary of the video,
f. An appropriate rating for the video (e.g., MPAA or TV rating),
g. A run time,
h. A run time for display, and
i. A nested list of human readable categories and sub-categories which effect how the VOD user interface presents the video.

In the embodiment of the package 500 structure shown in FIG. 5, the video asset provides video content 570 (e.g., the video file) along with video metadata 560 comprising information associated with playing the video for a subscriber. For instance, the video metadata 570 may includes information such as:
a. Information similar to the package metadata 510 and/or the title metadata 530,
b. A flag indicating whether encryption is required for the video,
c. The audio types available for the video (e.g., Dolby ProLogic, Dolby Digital, and Stereo),
d. The screen format of the video (e.g., Standard, Widescreen, and Letterbox),
e. The available languages for the video,
f. Indicator as to whether the video is encoded as HD content,
g. The available languages for sub-titles,
h. The available dubbed languages,
i. An indicator as to whether the video is copyright protected,
j. The overall bit rate of the video, and
k. The file size of the video.

Furthermore, in embodiment of the package 500 structure shown in FIG. 5, the still-image asset 580 includes still-image content 599 (e.g., “box cover” and “poster”) and still-image metadata 590 providing information that is used to describe the still-image content. In various embodiments, the still-image asset 580 may include one or more images that make up the still-image content 590 and corresponding still-image metadata 599 for each image. For instance, in one embodiment, each image of the still-image content 590 is a single BMP compressed image that may be used for the “Additional information” interface provided in the VOD service or to be shown on the library screen of the VOD service. In various embodiments, the still-image metadata 599 includes such information as:
a. Information similar to the package metadata 510, the title metadata 530, and/or the video metadata 560,
b. The image type (e.g., “box cover” or “poster”),
c. The pixel aspect ratio for the particular image of the still-image content 590, and
d. The file size of the particular image of the still-image content 590.

Returning now to FIG. 4, the APS 106, 156 may place the selected videos (e.g., the package for each video) to the VOD system 100, 150 resulting in the VOD system 100, 150 storing the package in storage accessible to the VOD system 100, 150. For example, in the system depicted in FIG. 1a, the APS 106 uploads the videos to the VOD system 100 and the VOD system 100 stores the uploaded video content in storage 102 and the metadata information may be stored elsewhere in the VOD system. In another embodiment, the APS 106, 156 may upload pointers for the selected videos to the VOD system 100, 150 and the VOD system 100, 150 may use these pointers to access the selected video content. For example, in the system depicted in FIG. 1b, the Integrated APS 156 may send the VOD system 150 pointers to the locations of the selected videos stored in the video content storage 152 in the package for each video instead of sending the actual video content in the package. Thus, the VOD system 150 then uses these pointers to access the videos on the video content storage 152. Once the videos have been uploaded to the VOD system 150, the VOD system 150 makes the videos available for viewing to subscribers.

In various embodiments, the process 400 continues with the APS 106, 156 instructing the VOD system 100, 150 to remove previously placed videos, shown as Step 480. This step may be accomplished in different ways according to various embodiments. For instance, in one embodiment, the APS 106, 156 may instruct the VOD system 100, 150 to remove any videos that have been posted for a certain amount of time. In another embodiment, the APS 106, 156 may instruct the VOD system 100, 150, at the time a new listing of videos is sent, to replace the previously placed videos with the new listing of videos on the VOD system 100, 150. In other embodiments, the Administrator using a terminal or personal computer as an input/output device can identify specific video clips to be removed from the system (either the VOD server or stored by the Web Site 108). The APS 106, 156 may use any number of criteria to instruct the VOD system 100, 150 to remove old videos. Finally, the process 400 completes at Step 490.

### Exemplary Database Layout

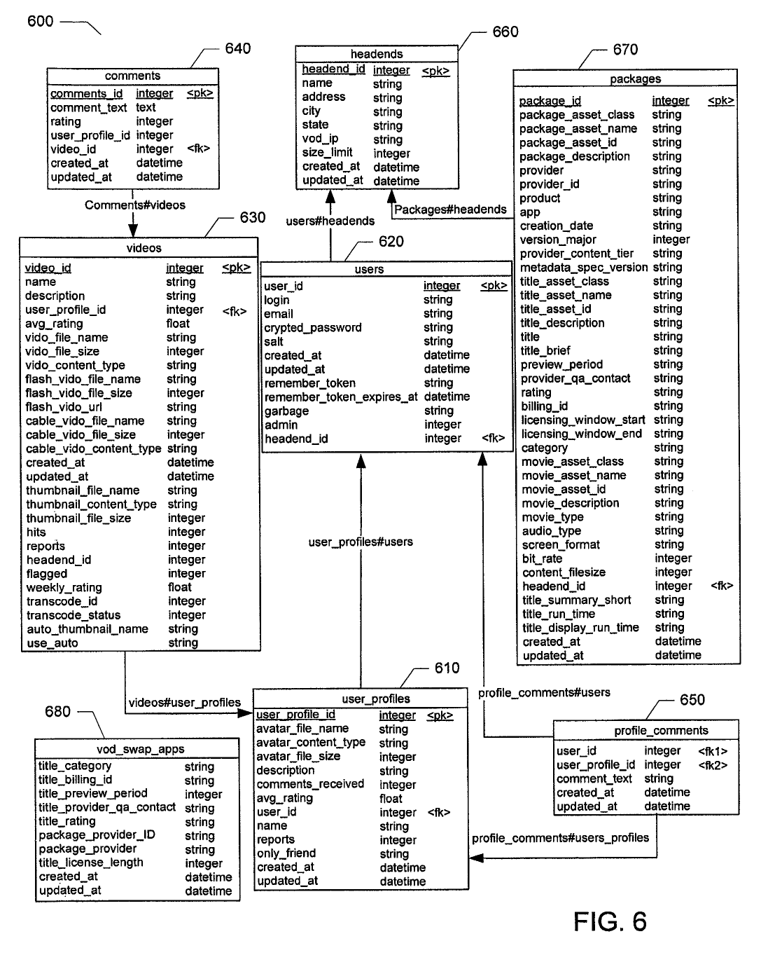

In various embodiments in which a database is utilized to store the information about the users of the System and the videos uploaded and stored in the System, the database may be constructed in any one of a number of common types of database software as known in the art, such as Oracle® or Microsoft SQL Server®. In addition, the database may be made up of a number of tables and may be managed via a database management system. For example, various tables are depicted in FIG. 6 for a database layout 600 according to a particular embodiment. However, it should be understood that the tables shown in FIG. 6 may not be the only tables that make up the database layout 600. The database layout 600 may include additional tables such as, for example, a user rights table that stores indicators of what functions the users of the System can perform on the Web Site 108.

In FIG. 6, a user_profiles table 610 is provided in the database layout 600 to store information about users (e.g., a user profile). This information pertains to registered users only. Anonymous users (e.g., those which access the web site but have not registered) are not known to the System. In some embodiments, the System may require all users to register, whereas other embodiments may require only users that post a video to register. In various embodiments, this table 610 includes a number of fields to store specific information about users. For instance, the user_profiles table 610 depicted in FIG. 6 includes a user_profile_id field. In various embodiments, this field serves as the primary key for the user_profiles table 610 and is unique for each record stored in the table. This particular field may be generated by various techniques. For instance, in one embodiment, this field is configured so that a unique identifier is automatically generated whenever a record is inserted into the user_profiles table 610.

The user_profiles table 610 may also include a field to store a user identifier (e.g., user_id). In one embodiment, this user identifier field may store a unique identifier for each user (which typically is associated with a single record in the profile table) who uses the Web Site 108. In another embodiment, the user identifier may not be unique within the system, but unique within the context of a cable service provider. The APS 106, 156 may serve multiple cable systems, and each user identifier is defined in the context of a cable system provider, or groups of providers. In various embodiments, the user identifier may be provided by the user when the user creates the user's profile or the user identifier may be provided by a system external to the System.

In addition, the user_profiles table 610 may include various fields that store other information about the particular user for each record. For instance, the user_profiles table 610 depicted in FIG. 6 includes such fields as name, avatar_file_name, and avg_rating. Thus, these fields store particular information about the user such as the user's name, the name of the file in which the user's avatar is stored, and the average rating the user has given videos he or she has reviewed.

In various embodiments, the database layout 600 also includes a users table 620 that stores records to provide additional information about users of the System. For instance, in one embodiment, this table 620 includes a login field. This field stores the particular user's login identification for uploading videos to the Web Site 108 and/or for providing feedback on particular videos. In addition, the table 620 includes a field (e.g., crypted_password) that stores the user's encrypted password. Furthermore, this table 620 includes a field that identifies the headend associated with the particular user (e.g., headend_id).

In various embodiments, the database layout 600 also includes a videos table 630 that stores records providing information on the videos uploaded into the System. For instance, the videos table 630 depicted in FIG. 6 includes a field to store information that identifies the video file and a storage location for the file in the System for a video uploaded to the Web Site 108 (e.g., vido_file_name). The video table 630 also includes a field to store the title of the video (e.g., name). This field may be queried to provide a listing of the videos stored on the System. Furthermore, the videos table 630 depicted in FIG. 6 includes a field to store a description for the particular video associated with the record in the videos table 630. In one embodiment, this description may be a freeform text field that stores a short explanation of the particular video that is provided by the user at the time the user uploads the video to the Web Site 108. This description (or the title) may be read by users visiting the Web Site 108 to obtain a quick explanation of the video and/or may be used to search the videos uploaded to the Web Site 108 based on criteria entered by the users.

In various embodiments, the record for each particular video stored in the videos table 630 is associated with a particular user via the user_profile_id field. This field is associated with the user_profile_id field stored in the user_profiles table 610. Thus, each video uploaded to the System can be linked to a particular user. Furthermore, each record stored in the videos table 630 may include additional fields such as the average rating the video has received from viewers (e.g., avg_rating) and the name and location of the thumbnail file for the uploaded video (e.g., thumbnail_file_name). Other fields may be included in this table 630 as shown in FIG. 6.

In various embodiments, the database layout 600 also includes a comments table 640. This table 640 is used to store records providing information on comments provided by users of the System on videos they have reviewed. For instance, the comments table 640 depicted in FIG. 6 includes a user_profile_id field that is associated with the user_profile_id field in the user_profiles table 610 and a video_id field that is associated with the video_id field in videos table 630. Therefore, each comment record stored in the comments table 640 can be associated with a particular user and a particular video. Furthermore, the table 640 includes a field to store the actual comment (e.g., comment_text).

The database layout 600 in various embodiments also includes a profile_comments table 650. Similar to the comments table 640, the profile_comments table 650 stores records providing information on comments provided by users of the System on other users. Thus, in the embodiment of the comments table 640 shown in FIG. 6, the table includes the user_id of the user who entered the comment into the System, the user_profile_id of the user the comment was entered about, and a comment_text field that stores the actual comment.

In addition, the database layout 600 may also include a headends table 660 that provides records detailing specific information about the headends associated with the VOD system 100, 150 and to particular users. For instance, the headends table 660 depicted in FIG. 6 includes fields to store the location of the headend such as address, city, and state. The table 650 also includes a field to store the open stream IP address associated with the headend (e.g., os_address), and a field to store the VOD pump IP address associated with the headend (e.g., vod_pump). In various embodiments, each record stored in the headends table 660 represents a particular headend and includes a unique identifier for the record. This unique identifier may be associated with a field in the users table 620 (e.g., headend_id) and the identifier is stored in this field to link users with their associated headends. Typically, when a user first registers with the system, they are prompted for a service location and cable system provider, so that once the system knows the user's user_id, the system is able to ascertain which headend serves that user.

Furthermore, in various embodiments, the database layout 600 may also include a table that provides the information for various packages uploaded to the VOD system 100, 150. For example, the database layout 600 in the embodiment shown in FIG. 6 includes a packages table 670 that provides information for the various packages that are uploaded into the VOD system 100, 150. In various embodiments, the package may be required to conform to a specific format to be loaded into a cable service provider's VOD system 100, 150. Thus, the packages table 670 depicted in FIG. 6 include fields to hold information for this specific format. For example, the packages table 670 includes a provider field and a provider_id field. These fields store information on the provider associated with video content sent in the package to the VOD system 100, 150. For instance, the particular provider may be the provider who is associated with the Web Site 108. Therefore, the content (e.g., videos) that is uploaded from the Web Site 108 to the VOD system 100, 150 is marked as coming from this particular provider.

In addition, the fields in the packages table 670 store additional information such as the rating of the asset (e.g., G, PG, or R), the category the asset should be listed under in the VOD system 100, 150 (such as “New Releases” or “Subscriber Provided Content”), and screen format for the particular content. Furthermore, the packages table 670 may store the headend_id for the headend associated with the VOD system 100, 150 for which the package is to be uploaded to.

Finally, in various embodiments, the database layout 600 includes a vod_swap_apps table 680. In general, this table 680 contains fields that hold default values for certain metadata that is provided for videos that are uploaded to the VOD system 100, 150. For instance, the vod_swap_apps table 680 includes the fields package_provider_id and package_provider. These fields may hold values that identify the provider that hosts the Web Site 108 on which the videos are uploaded. Therefore, when a package for a video is uploaded to the VOD system 100, 150, the cable service provider can look at these values to determine where the package originated from. In addition, in various embodiments, this table 680 may also include fields related to the service (e.g., OpenStream webservice) used to upload the packages into the VOD system 100, 150 and the device (e.g., server) the APS 106, 156 is running on. In various embodiments, these defaults are maintained by the Administrator.

### Graphical User Interface

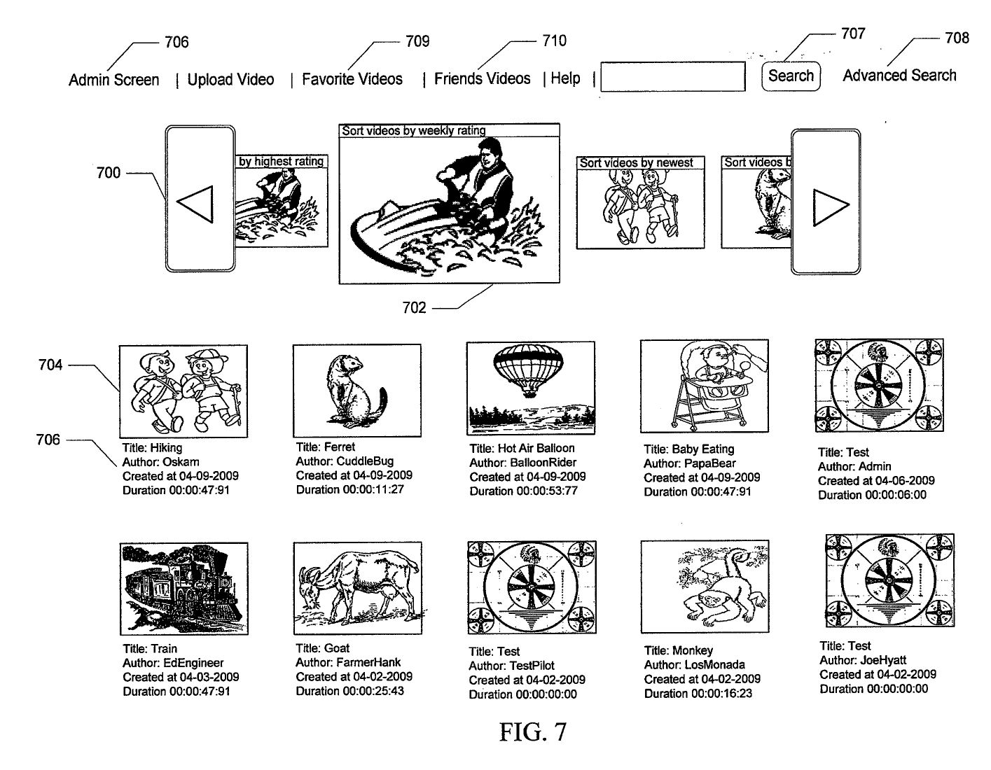

FIG. 7 illustrates one embodiment of a user interface (“UI”) in the form of a web-page or screen provided by the Web Site 108 to a user. The UI is provided both to an end user as well as to the Administrator. However, certain options on the screen may only be available to the Administrator. For instance, only the Administrator may be provided with the option of selecting the Admin Screen as shown at the top left corner of the screen. Generally, because the Administrator can invoke any function that an end user can do, as well as additional functions, the UI is described in the context of a system administrator.

FIG. 7 illustrates one administrator screen which provides a toolbar of functions 706 available for selection. The next section 700 allows the user to view various “popular” videos by moving the cursor to effect a scrolling action of the videos, and thus can select from the various categories. Presently, the image 702 displays the function of sorting videos by their weekly rating. A “back” and “forward” command icon also provide for scrolling.

The list of video clips is shown below, and the first row 704 illustrates five videos. Each can be individually selected for viewing by the user. The thumbnail image is derived from the video clip, and thus represents a still image from the video clip. Underneath each video clip is information 706 associated with the clip, which comprises the title (provided by the user when uploaded), the author (based on the user's user_id and provided by the System based on the user's profile), the creation date (provided by the System when the video was uploaded), and the duration (provided by the System based on the run time of the video clip). The UI also provides the ability to search 707 for key terms in the title or an Advanced Search 708, which allows more sophisticated searching based, in part, on Boolean logic, or other search capabilities. The UI also provides the ability to view videos indicated as a “favorite” 709 and to view the videos selected by other users 710.

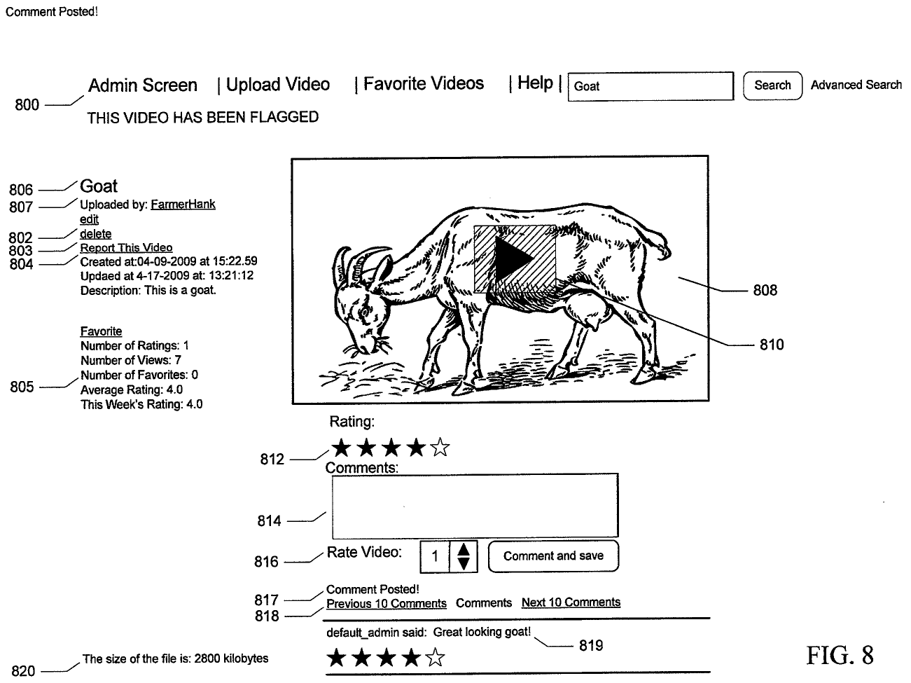

FIG. 8 illustrates another UI view wherein information on a particular video clip can be examined. Note that the particular UI shown in FIG. 8 is what is provided to the Administrator. However, as previously described, non-Administrator users in various embodiments are provided with a similar screen, but with fewer options made available. In addition, users in various embodiments may also be provided with different options. For instance, a user who is viewing a video that he or she did not upload is typically not given the options of editing 802 and/or deleting the video 803.

The still image of the video clip 808 is featured prominently along with a control button 810 to play the video. The information associated with the video is shown alongside the video 808, with the title 806 and originator 807. Additional functions of “edit” 802, “delete” 803, and “Report this video” 804 allow the user to edit information associated with it, delete the video, or flag it by reporting. In various embodiments, the Administrator can delete any video, whereas an end-user can only delete video clips he or she has provided. The ability to “Report this video” 804 is primarily an end user capability, designed to flag potentially offensive videos for the Administrator to review. The other information provided includes the date and time the video clip was created, when it was uploaded, and the description, which can be used as when searching.

The other information 805 provides a summary of the feedback the system has maintained for the video, including how many users have rated it, the number of viewings, the number of times it has been included as a “Favorite,” the average user rating, and the present ratings. Other parameters can be defined as to how the popular the video clip is. Other input fields allow a rating input 816 and a comment box 814 for providing text commentary. Other information indicates whether comments have been posted 817, selecting among the comments 818, and the comments themselves 819, which can be provided in the absence of ratings. Further, the size of the file 820 is also indicated.

### Exemplary User Functions on VOD System

After the video has been placed in the VOD system, the subscriber of the video service provider can thereafter request and view the video. In one embodiment, this is done by a cable service subscriber invoking a VOD service. The VOD service typically allows a user to select from a listing of video titles available for viewing in the VOD library. The titles may be listed in alphabetical order, by category, or by other information. Further, in various embodiments, tools for searching may be provided to the viewer. These mechanisms may be adapted to allow a cable subscriber to search various UGC video clips for viewing.

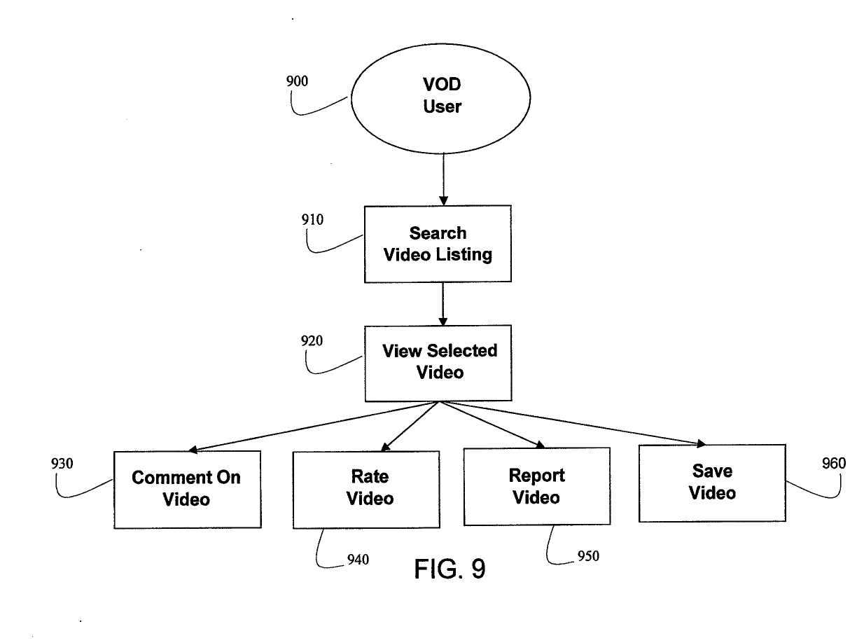

In particular, the process 900 shown in FIG. 9 provides the functions a user (e.g., cable service provider subscriber) can perform within the VOD service with regard to the uploaded video clips (e.g., UGC video clips) according to various embodiments. Thus, once the APS 106, 156 has place the video to the cable provider's VOD system 100, 150, the user can search a listing of the uploaded videos, shown as Step 910.

For instance, in one embodiment, the menus associated with the VOD service are augmented to include a category indicating “User Generated Content.” Once selected, the viewer may be presented a listing by title of the most popular video clips. Furthermore, the source (e.g., user_id) of the originator may also be indicated, as well as the run time. Thus, the user browses the list of videos that have been uploaded via the APS 106, 156, and in Step 920, the user selects a particular video from the list to view. In response, the cable provider's headend 114 streams the selected video to the user's set top box 120a, 120b, 120c.

In addition, the run time of such videos may be relatively short, and to facilitate a user's viewing experience, the VOD service may automatically concatenate and stream a plurality of user generated content video clips so that the viewer can seem them without having to individually select each title. Thus, set of the most popular video clips may be presented as a single selection in addition as individual titles. In this embodiment, each video clip may be marked by a “bookmark,” so that each video clip may be skipped by the viewer selecting the appropriate commands on the remote controller.

In particular embodiments, the user of the VOD service may also be provided with functionality similar to users of the Web Site 108. For example, the VOD service may allow the user to comment on a video, shown as Step 930. In one embodiment, the VOD application that resides on the user's set top box 120a, 120b, 120c may include a function that allows a user to type in a comment for a video the user has viewed. For example, the user may enter the comment into the set top box 120a, 120b, 120c via a keyboard provided on the television screen that the user controls via one or more buttons on the user's remote control. The VOD application may then send the comment back to the headend 114 of the cable provider's system. The comment may be stored on the cable provider's VOD system 100, 150 or may be uploaded to the APS 106, 156 and stored.

In other embodiments, the user may also be able to rate the video, shown as Step 940. Similar to user of the Web Site 108, the VOD service in various embodiments allows a user to enter a rating for a particular video. For example, in one embodiment, the user enters the rating by selecting a particular button on the user's remote control. As in the case with the user providing comments, the VOD application on the user's set top box 120a, 120b, 120c may then forward the rating to the cable provider's headend 114. In similar fashion, the user may also be able to report a video, shown as Step 950.

Finally, in Step 960, a user may be able to save a video in an individual “Favorite” category. This step may entail different aspects according to various embodiments. For instance, in one embodiment, the VOD service may save an indicator that the user wants to “save” the video, similar to marking a favorite video on the Web Site 108. Thus, a copy of the video is not saved for the particular user. In another embodiment, videos may be periodically removed. Therefore, in this embodiment, the VOD service may save a copy of the video for the user. For example, the VOD service may save a copy of the video locally on the user's set top box 120a, 120b, 120c. In another example, the VOD service may indicate to the cable provider's headend 114 to save a copy of the video in separate content storage within the cable provider's system. Furthermore, the VOD service may also provide an option to the user to access these saved videos.

### Removal of Videos

As previously described, the APS 106 (or Integrated APS 156) may instruct or provide information to the VOD system 100, 150 to remove old videos from availability based on any number of criteria. For instance, in one embodiment, the APS 106, 156 may provide a time-stamp to the VOD system 100, 150 along with the uploaded videos that the VOD system 100, 150 uses to automatically remove the uploaded videos after the time period indicated by the time stamp. In another embodiment, the Administrator may access the VOD system 100, 150 through the APS 106, 156 and manually delete the old videos from the VOD system 100, 150 (which may also be done if an objectionable video is reported by a user). Finally, in another embodiment, the APS 106, 156 may instruct the VOD system 100, 150 to replace the current videos with the new videos every time the APS 106, 156 uploads a new listing of videos to the VOD system 100, 150.

That which is claimed:

1. A method for providing a package to a video service provider, the method comprising the steps of:
(a) receiving, at a computer system hosting an Internet web site, a first digital video file in a first encoding format from a first user accessing said Internet web site;
(b) receiving, at said computer system, text describing said first digital video file from said first user;
(c) generating a second digital video file in a second encoding format compatible with said Internet web site by transcoding said first digital video file from said first encoding format to said second digital video file in said second encoding format;
(d) generating first metadata for said second digital video file based on
(1) said text received from said first user,
(2) data generated by said computer system based on processing said second digital video file, and
(3) data provided to said computer system and stored in a first disk storage subsystem accessible to said computer system prior to receipt of said text;
(e) storing said second digital video file and said first metadata in said first disk storage subsystem;
(f) making available said second digital video file on said Internet web site for viewing by a plurality of users visiting said Internet web site;
(g) generating a third digital video file in a third encoding format compatible with said video service provider by transcoding said first or said second digital video file to said third digital video file in said third encoding format;
(h) generating second metadata for said third digital video file based on
(1) said text received from said first user,
(2) data generated by said computer system based on processing said third digital video file, and
(3) data provided to said computer system and stored in said first disk storage subsystem prior to receipt of said text;
(i) storing a package comprising said third digital video file in said third encoding format and said second metadata in a second disk storage subsystem; and
(j) providing said package to said video service provider, wherein said video service provider streams said third digital video file in said third encoding format to a second user who is a subscriber of said video service provider in response to said second user selecting said third digital video file for viewing from said video service provider.

2. The method of claim 1, wherein said video service provider comprises a cable service provider system and said cable service provider streams said third digital video file to said second user over said cable service provider's cable network.

3. The method of claim 2, wherein said second user selects said third digital video file for viewing from a VOD service.

4. The method of claim 1, wherein said video service provider comprises a wireless service provider and said video service provider streams said third digital video file to a wireless device operated by third user.

5. The method of claim 1, wherein said first disk storage subsystem and said second disk storage subsystem are in a same storage system.

6. The method of claim 1 further comprising the step of:
receiving popularity data associated with said second digital video file from at least one user of said plurality of users, wherein said popularity data is a numerical indicator.

7. The method of claim 6, wherein the step of storing said third digital video file in said third encoding format in said second disk storage subsystem is performed based at least partially on said popularity data.

8. The method of claim 1, wherein the step of storing said third digital video file in said third encoding format in said second disk storage subsystem is preceded by: (1) determining a number of times said second digital video file has been selected for viewing by said plurality of users over a predefined time period; and (2) determining said number of times exceeds a threshold value.

9. A system for providing a package to a video service provider providing a media service comprising:
a computing system adapted to:
(a) host an Internet web site;
(b) receive a first digital video file in a first encoding format from a first user accessing said Internet web site;
(c) receive text describing said first digital video file from said first user;
(d) generate a second digital video file in a second encoding format compatible with said Internet web site by transcoding said first digital video file from said first encoding format to said second digital video file in said second encoding format;
(e) generate first metadata for said second digital video file based on
(1) said text received from said first user,
(2) data generated by said computing device based on processing said second digital video file, and
(3) data provided to said computing device and stored in a first disk storage subsystem accessible to said computer device prior to receipt of said text;
(f) store said second digital video file in said second encoding format and said first metadata in said first disk storage subsystem;
(g) make available said second digital video file on said Internet web site for viewing by a plurality of users visiting said Internet web site;
(h) generate a third digital video file in a third encoding format compatible with said video service provider by transcoding said first or said second digital video file to said third digital video file in said third encoding format;
(i) generate second metadata for said third digital video file based on
(1) said text received from said first user,
(2) data generated by said computing device based on processing said third digital video file, and
(3) data provided to said computing device and stored in said first disk storage subsystem prior to receipt of said text;
(j) store a package comprising said third digital video file in said third encoding format and said second metadata in a second disk storage subsystem; and
(k) provide said package to said video service provider, wherein said video service provider streams said third digital video file in said third encoding format to a second user who is a subscriber of said video service provider in response to said second user selecting said third digital video file for viewing from said video service provider.

10. The system of claim 9, wherein said video service provider comprises a cable service provider and said cable service provider streams said third digital video file to said second user over said cable service provider's cable network.

11. The system of claim 10, wherein said media service comprises a VOD service.

12. The system of claim 9, wherein said video service provider comprises a wireless service provider and said video service provider streams said third digital video file to a wireless device operated by second user.

13. The system of claim 9, further comprising a storage system comprising said first disk storage subsystem and said second disk storage subsystem and said computing system is adapted to stream said third digital video file to said third user.

14. The system of claim 9, wherein said computing system is further adapted to:
receive popularity data from at least one user of said plurality of users, said popularity data being a numerical indicator.

15. The system of claim 14, wherein said computing system stores said third digital video file in said third encoding format in said second disk storage subsystem based at least partially on said popularity data.

16. The system of claim 9, wherein said computing device stores said third digital video file in said third encoding format in said second disk storage subsystem is preceded by: (1) determining a number of times said digital video file has been selected for viewing by said plurality of users over a predefined time period; and (2) determining said number of times exceeds a threshold value.

17. A computer-readable medium containing code executable by a processor for providing a package to a video service provider comprising computer-readable program instructions adapted for:
(a) receiving a first digital video file in a first encoding format from a first user accessing an Internet web site;
(b) receiving text describing said first digital video file from said first user;
(c) generating a second digital video file in a second encoding format compatible with said Internet web site by transcoding said first digital video file from said first encoding format to said second digital video file in said second encoding format;
(d) generating first metadata for said second digital video file based on
(1) said text received from said first user,
(2) data generated by said computer system based on processing said second digital video file, and
(3) data retrieved from a first disk storage subsystem and received prior to said text;
(e) storing said second digital video file and said first metadata in said first disk storage subsystem;
(f) making available said second digital video file on said Internet web site for viewing by a plurality of users visiting said Internet web site;
(g) generating a third digital video file in a third encoding format compatible with said video service provider by transcoding said first or said second digital video file to said third digital video file in said third encoding format compatible;
(h) generating second metadata for said third digital video file based on
(1) said text received from said first user,
(2) data generated by said computer system based on processing said third digital video file, and
(3) data retrieved from said first disk storage subsystem and received prior to said text;
(i) storing a package comprising said third digital video file in said third encoding format and said second metadata in a second disk storage subsystem; and
(j) providing said package to said video service provider, wherein said video service provider streams said third digital video file in said third encoding format to a second user who is a subscriber of said video service provider in response to said second user selecting said third digital video file for viewing from said video service provider.
